(19) United States
(12) Patent Application Publication
(10) Pub. No.: US 2005/0140263 A1
(43) Pub. Date: Jun. 30, 2005

(54) Color picture tube apparatus

(75) Inventors: Hiroshi Sakurai, Takatsuki-shi (JP); Etsuji Tagami, Takatsuki-shi (JP)

Correspondence Address: MERCHANT & GOULD PC, P.O. BOX 2903, MINNEAPOLIS, MN, 55402-0903, US

(73) Assignee: Matsushita Toshiba Picture Display Co., Ltd., Takatsuki-shi (JP)

(21) Appl. No.: 10/991,233

(22) Filed: Nov. 17, 2004

(30) Foreign Application Priority Data
Dec. 25, 2003 (JP) 2003-431105

(51) Int. Cl. H01J 29/70

(52) U.S. Cl. 313/440

(57) ABSTRACT

A bar-shaped element includes magnets at both ends and a magnetic material connecting the magnets to each other. One end in a major axis direction of the bar-shaped element is an N-pole, and the other end is an S-pole. A pair of bar-shaped elements sandwich a deflection yoke in a horizontal direction, with the major axis direction thereof being parallel to a vertical direction, and each of the bar-shaped elements is placed at a position between the end of a horizontal deflection coil on a phosphor screen side and a central position of a core in a tube axis direction, in such a manner that the magnetic poles at both ends are opposite to each other between the pair of bar-shaped elements. Because of this, PQH misconvergence is corrected without influencing power consumption at low cost by a simple method without using an auxiliary coil and a correction circuit, whereby satisfactory convergence can be realized.

### BACKGROUND OF THE INVENTION

1. Field of the Invention

The present invention relates to a color picture tube apparatus for deflecting a plurality of electron beams emitted from an electron gun arranged in an in-line shape, and displaying a color image on a phosphor screen.

2. Description of the Related Art

Generally, in a color picture tube apparatus for deflecting a plurality of electron beams emitted from an electron gun arranged in an in-line shape and displaying a color image on a phosphor screen, distortion correcting magnets are placed usually in the vicinity of upper and lower portions on a screen side of a deflection yoke so as to correct pin-cushion distortion of upper and lower sides of a raster. In this case, when the deflection angle becomes larger, the screen becomes flatter, the design is changed so as to make a horizontal deflection magnetic field more uniform, and the like, the side effect of the magnets on convergence is increased, and consequently, misconvergence called PQH occurs, in which a vertical line of R (red) shifts in the right direction with respect to a vertical line of B (blue) in corner portions of a raster. The PQH misconvergence cannot be eliminated merely by changing the winding distribution of a coil.

In order to correct the above-mentioned misconvergence, correction methods using a coil such as a method for providing a correction circuit using a saturable reactor coil (see, for example, JP2001-23541A), a method using an auxiliary coil (see, for example, JP7(1995)-31989B), and the like have been proposed.

On the other hand, various kinds of methods for correcting an electron beam track using magnets have been proposed.

JP10(1998)-241602A discloses a color cathode-ray tube apparatus in which a pair of bar-shaped bodies, each including a plurality of magnets and magnetic materials disposed alternately at a short pitch, are placed so as to sandwich a deflection yoke, with the longitudinal direction thereof being parallel to a vertical direction, whereby color purity is corrected without degrading convergence.

Furthermore, JP62(1987)-86650U discloses a color cathode-ray tube apparatus in which misconvergence of electron beams on both sides is corrected by placing one magnet in each of four quadrants partitioned by a horizontal axis and a vertical axis.

However, according to the above-mentioned correction method of JP2001-23541, A there are the following problems: power consumption is increased due to the correction circuit; the correction circuit itself increases cost; furthermore, when another correction circuit is used together, the circuit configuration becomes complicated; and the like.

Furthermore, according to the above-mentioned correction method of JP7(1995)-31989B, there are the following problems: the auxiliary coil increases cost; power consumption is increased in the same way as in JP2001-23541A due to the circuit for driving the auxiliary coil, leading to an increase in circuit cost; furthermore, when another correction circuit is used together, the circuit configuration becomes complicated; and the like.

Furthermore, according to the correction methods of JP10(1998)-241602A and JP62(1987)-86650U, there is a problem that vertical line misconvergence on a horizontal axis (XH) newly occurs.

### SUMMARY OF THE INVENTION

The present invention has been achieved so as to solve the above-mentioned problems of the prior art, and its object is to provide a color picture tube apparatus in which PQH misconvergence can be corrected without influencing power consumption and without degrading XH misconvergence, at low cost by a simple method without using an auxiliary coil and a correction circuit, whereby satisfactory convergence is realized.

In order to achieve the above-mentioned object, a color picture tube apparatus of the present invention includes a deflection yoke including a horizontal deflection coin, a vertical deflection coil, and a core. The apparatus deflects a plurality of electron beams emitted from an electron gun arranged in an in-line shape using the deflection yoke, and displays a color image on a phosphor screen. The apparatus further includes a pair of bar-shaped elements, each including a magnetic material and magnets disposed at both ends of the magnetic material. One end in a major axis direction of each of the pair of bar-shaped elements is an N-pole, and the other end is an S-pole. The pair of bar-shaped elements sandwich the deflection yoke in a horizontal direction, with the major axis direction thereof being parallel to a vertical direction, and each of the pair of bar-shaped elements is placed at a position between an end of the horizontal deflection coil on the phosphor screen side and a central position of the core in a tube axis direction, in such a manner that magnetic poles at both the ends are opposite to each other between the pair of bar-shaped elements.

Herein, “magnetic poles at both the ends are opposite to each other between the pair of bar-shaped elements” means that an N-pole at one end of one bar-shaped element of the pair of bar-shaped elements parallel to the vertical direction is positioned on a upper side and an S-pole at the other end thereof is positioned on a lower side, and an S-pole at one end of the other bar-shaped element is positioned on an upper side and an N-pole at the other end thereof is positioned on a lower side.

These and other advantages of the present invention will become apparent to those skilled in the art upon reading and understanding the following detailed description with reference to the accompanying figures.

### BRIEF DESCRIPTION OF THE DRAWINGS

FIG. 1 is a perspective view of a deflection yoke of a color picture tube apparatus according to one embodiment of the present invention.

FIG. 2 is a schematic view showing bar-shaped elements provided at the deflection yoke of the color picture tube apparatus according to one embodiment of the present invention, and lines of magnetic force due to the bar-shaped elements and force influencing electron beams.

FIG. 3 is a schematic view showing convergence of the color picture-tube apparatus according to one embodiment of the present invention.

FIG. 4 is a schematic view showing lines of magnetic force and force influencing electron beams in the case of using a pair of bar-shaped magnets.

FIG. 5 is a schematic view showing convergence in the case of using a pair of bar-shaped magnets.

FIG. 6 is a schematic view showing lines of magnetic force and force influencing electron beams in the case of using only four magnets with magnetic materials removed.

FIG. 7 is a schematic view showing convergence in the case of using only four magnets with magnetic materials removed.

FIG. 8 is a schematic view showing PQH misconvergence in a conventional color picture tube apparatus.

### DESCRIPTION OF THE PREFERRED EMBODIMENTS

According to the color picture tube apparatus of the present invention, by forming a bar-shaped element, using a magnetic material and magnets connected to both ends of the magnetic material, and conveniently arranging a pair of the bar-shaped elements, only PQH misconvergence can be corrected mainly, and an ideal corrected magnetic field distribution with substantially no side effect can be realized. Thus, PQH misconvergence can be corrected at low cost by a relatively simple method without using an auxiliary coil and a correction circuit, and without increasing power consumption.

In the color picture tube apparatus of the present invention, it is preferable that the N-poles and the S-poles at both ends of the bar-shaped elements are substantially positioned respectively on a diagonal line of the phosphor screen, when seen along a tube axis. More specifically, it is preferable that, when the bar-shaped elements are projected onto the phosphor screen along the tube axis, the N-poles and the S-poles at both ends of the bar-shaped elements are positioned respectively on a diagonal line of the phosphor screen in a substantially rectangular shape. According to this configuration, PQH misconvergence can be corrected effectively with the magnetic force of fewer magnets without disturbing the entire convergence.

Furthermore, it is preferable that, assuming that a length in a major axis direction of the magnetic material is a, and each length in the major axis direction of the magnets disposed at both ends of the magnetic material is b, a relationship: 2b<a<4b is satisfied. According to this configuration, only PQH misconvergence can be corrected, suppressing the occurrence of XH misconvergence.

Hereinafter, the embodiment of the present invention will be described with reference to the drawings.

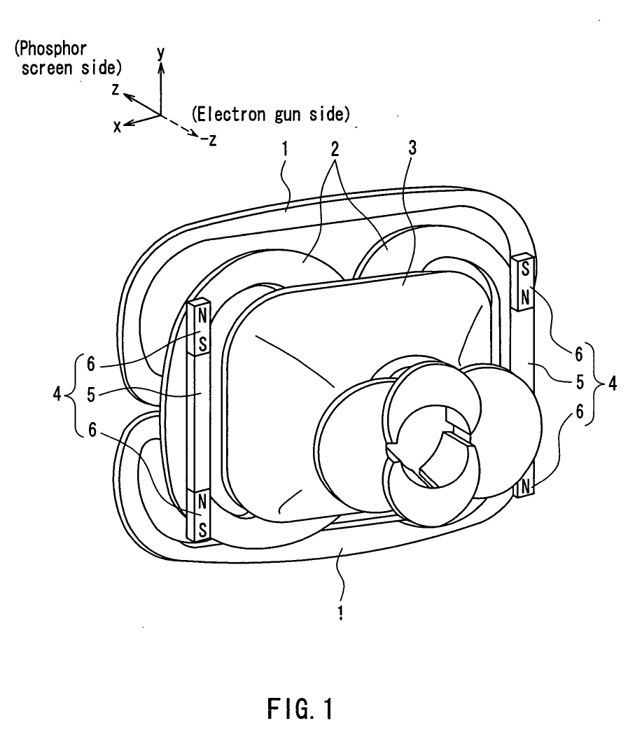

FIG. 1 is a perspective view showing a deflection yoke in a color picture tube apparatus according to one embodiment of the present invention. The deflection yoke includes a horizontal deflection coil 1 and a vertical deflection coil 2 in this order from a funnel (not shown) side. Actually, a resin frame for insulating the horizontal deflection coil 1 from the vertical deflection coil 2 is present therebetween; however, herein, the resin frame is omitted so as to simplify the figure and clearly show each component. Furthermore, an outer circumference of the vertical deflection coil 2 is partially covered with a core 3. Herein, as shown in FIG. 1, it is assumed that a horizontal direction is an x-axis, a vertical direction is a y-axis, and a tube axis direction is a z-axis. It also is assumed that the positive direction of the z-axis is a direction from the deflection yoke to a phosphor screen (not shown). The above-mentioned configuration is similar to that of a conventional deflection yoke.

The present invention is characterized in that a pair of bar-shaped elements 4 are provided in the vicinity of the core 3 so as to sandwich the core 3 in the x-axis direction. Although the pair of bar-shaped elements 4 are held on the resin frame via a holding mechanism, the holding mechanism is omitted since the configuration thereof is optional. There is no particular limit to a specific configuration of the holding mechanism. For example, it is possible to use a holding mechanism which is basically the same as that generally used for allowing distortion correcting magnets to be held on the resin frame, such as a fit-in system in which a pocket or tunnel fit-in shape is provided on the resin frame, and the bar-shaped element 4 is fit therein, an attachment system in which a groove or projection for regulating a position is provided on the surface of the resin frame, and the bar-shaped element 4 is brought into contact with the groove or projection so as to be attached to be fixed thereto, etc.

The pair of bar-shaped elements 4 are respectively composed of one bar-shaped magnetic material 5 and a pair of bar-shaped magnets 6 connected to both ends of the magnetic material 5. The pair of magnets 6 are connected to the magnetic material 5 so that one end in the major axis direction of each of the pair of bar-shaped elements 4 is an N-pole, and the other end is an S-pole. In the present invention, the “magnet” refers to a so-called permanent magnet, which is a substance that radiates magnetic lines of force to generate a magnetic field, thereby exhibiting the property of attracting a magnetic material such as iron. Furthermore, in the present invention, the “magnetic material” refers to a substance that absorbs magnetic lines of force in a magnetic field generated by another substance such as a magnet, thereby exhibiting the property of being magnetized temporarily to be attracted to the magnet. Then, the pair of bar-shaped elements 4 are placed in such a manner that the major axis direction thereof is parallel to the y-axis, and magnetic poles at both ends of the respective bar-shaped elements 4 are opposite to each other between the pair of bar-shaped elements 4. In the z-axis direction, the bar-shaped element 4 is placed in a range from the position of the end of the horizontal deflection coil 1 on the phosphor screen side to the central position of the core 3.

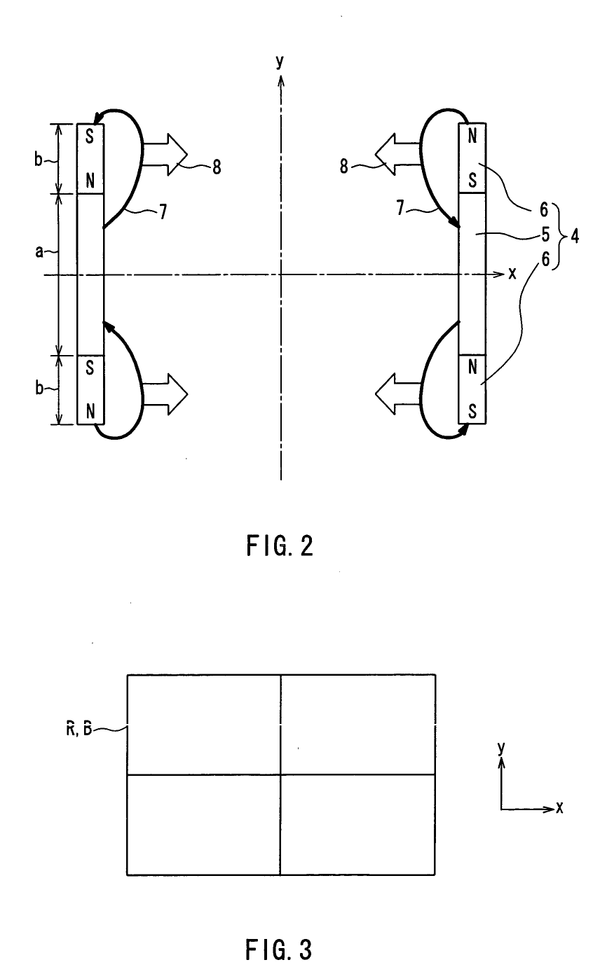

Furthermore, it is preferable that when the N-poles and the S-poles at both ends of the bar-shaped elements 4 are projected onto the phosphor screen (or raster) along the tube axis, they are substantially positioned respectively on a diagonal line of the phosphor screen (or raster) in a substantially rectangular shape. Furthermore, as shown in FIG. 2, it is preferable that, assuming that the length in the major axis direction of the magnetic material 5 is a, and the length in the major axis direction of one magnet 6 is b, a relationship: 2b<a<4b is satisfied.

The configuration of the color picture tube apparatus of the present invention may be similar to that of the conventional example, except that the above-mentioned pair of bar-shaped elements 4 are provided.

Specific Example of the Present Invention

As a more specific design numerical value, an example of application to a wide CRT with a display screen diagonal size of 86 cm will be described. The bar-shaped element 4 has an entire length in the major axis direction of 85 mm, a thickness (size in the z-axis direction) of 3 mm, a=45 mm, and b=20 mm. In the z-axis direction, a pair of bar-shaped elements 4 are placed in such a manner that the surface of each bar-shaped element 4 on the phosphor screen side is matched with an x-y plane including the end of the core 3 on the phosphor screen side, and in the x-axis direction, placed at positions 10 mm away from the core 3 in the x-axis direction. The PQH correction amount may be adjusted by adjusting the quantity of magnetization of the magnets 6 in accordance with the occurrence amount of PQH or by attaching a magnetic shunt alloy. In this case, the thickness of each bar-shaped element 4 may be varied; however, this thickness does not influence the effect. As the material for the bar-shaped element 4, ferrite generally can be used for the magnetic material 5. Herein, although Ni-based ferrite is used, Mn-based ferrite also may be used. As the magnet 6, a commercially available magnet generally is used and is attached to each end of the magnetic material 5. However, the magnetic material 5 and the magnets 6 also can be formed simultaneously by magnetizing both ends of bar-shaped ferrite.

Function of the Invention

Next, the function of the PQH correction by the bar-shaped element 4 in the present invention will be described.

FIG. 2 schematically shows a state of lines of magnetic force 7 in a range of influencing electron beams (not shown), among the lines of magnetic force generated from the bar-shaped elements 4, seen from the phosphor screen side toward the electron gun side. Furthermore, force 8 influencing electron beams due to the lines of magnetic force 7 also is shown. As is apparent from FIG. 2, the force 8 has a function of pushing electron beams back to an inner side (center of a raster) in corner portions. This function acts stronger as electron beams approach poles (ends) of the bar-shaped elements 4. Electron beams passing through a deflection yoke are arranged generally in the order of R (red), G (green), and B (blue) from the right to the left in the x-axis direction, seen from the phosphor screen side to the electron gun side. Therefore, in a right-half region of the raster, the electron beam of R is influenced more by the force pushing it back to the center of the raster, compared with the electron beam of B, and in a left-half region of the raster, the electron beam of B is influenced more by the force pushing it back to the center of the raster, compared with the electron beam of R. Consequently, the PQH misconvergence as shown in FIG. 8 can be corrected as shown in FIG. 3.

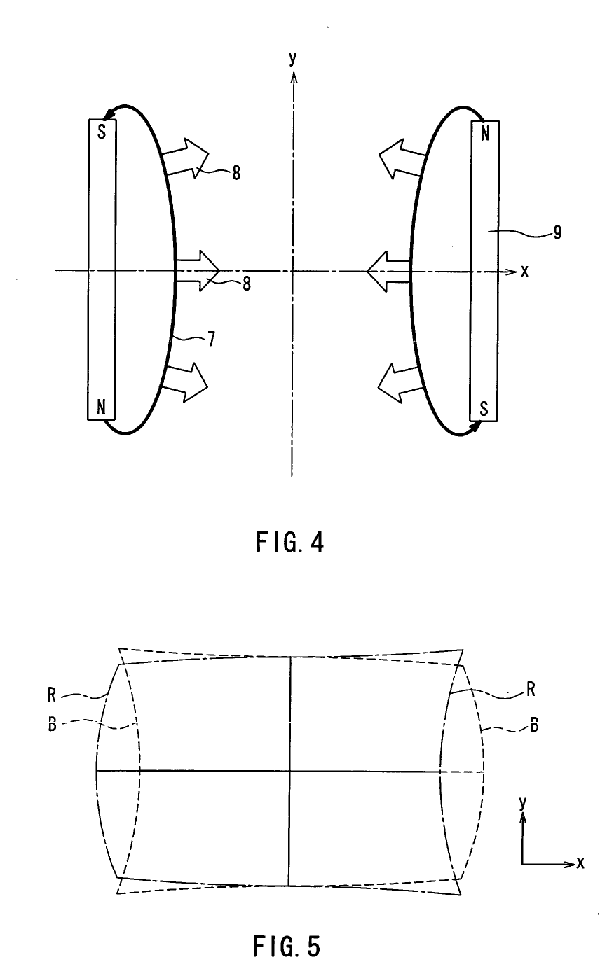

Herein, in order to further clarify the function of the bar-shaped elements 4 of the present invention, the function in the case of merely using bar-shaped magnets 9 in place of the bar-shaped elements 4 will be described. FIG. 4 schematically shows the lines of magnetic force 7 due to the bar-shaped magnets 9 and the force 8 influencing electron beams in the same way as in FIG. 2. As is apparent from FIG. 4, the bar-shaped magnets 9 have a function of pushing electron beams back to an inner side (center of a raster) even in the circumferential portions on the x-axis, as well as in the corner portions. Therefore, the PQH misconvergence in FIG. 8 is changed as shown in FIG. 5. That is, although the PQH misconvergence is corrected only partially, XH misconvergence also occurs. Consequently, misconvergence cannot be eliminated as a whole. In other words, an R vertical line and a B vertical line in the circumferential portions in the x-axis direction merely are moved relatively in the x-axis direction. Unless PQH is corrected without changing XH, effective PQH correction cannot be performed.

Even regarding the pair of bar-shaped bodies including a plurality of magnets and magnetic materials placed alternately at a short pitch described in JP10(1998)-241602A, in the same way as in the bar-shaped magnets 9 shown in FIG. 4, the R vertical line and the B vertical line in the circumferential portions in the x-axis direction merely are moved relatively in the x-axis direction by applying force similar to that of the bar-shaped magnets 9 shown in FIG. 4 with respect to electron beams in the corner portions and the circumferential portions on the x-axis. Furthermore, in JP10(1998)-241602A, by placing the pair of bar-shaped bodies in a region where the interval between the electron beam of R and the electron beam of B is decreased (that is, in a region closer to the phosphor screen with respect to the deflection yoke), color purity can be corrected while decreasing the influence on convergence. Thus, the pair of bar-shaped bodies in JP10(1998)-241602A do not have a PQH correction effect.

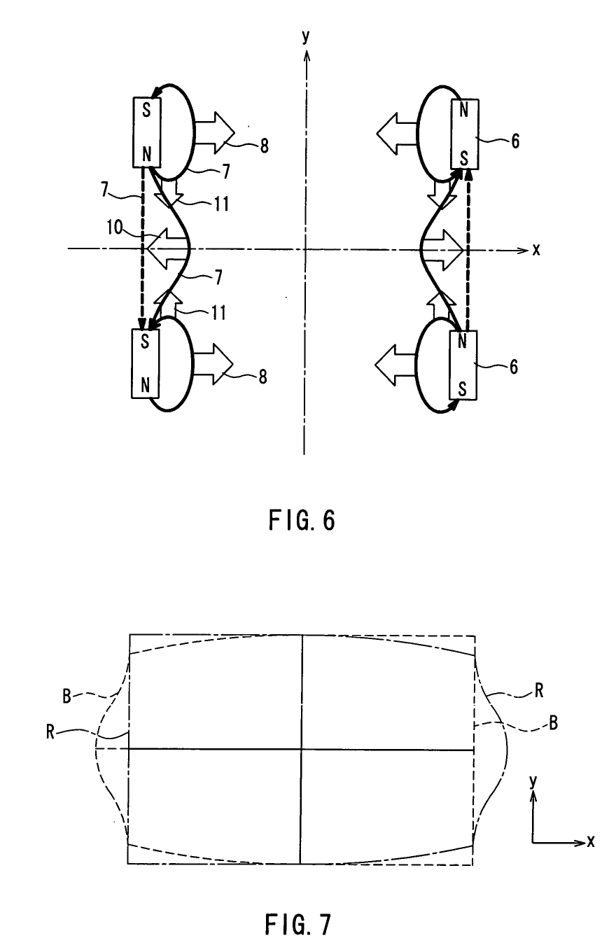

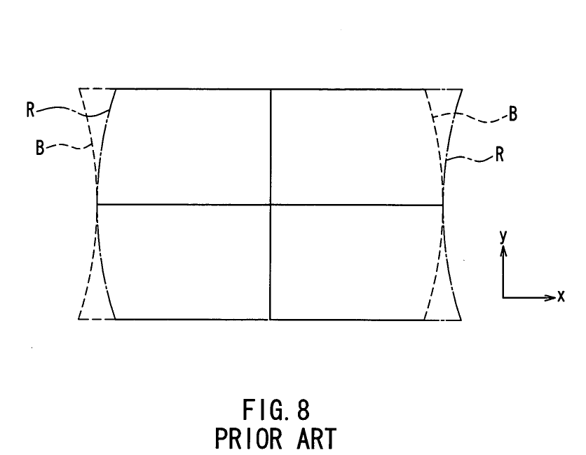

Furthermore, the magnet arrangement described in JP62(1987)-86650U is similar to the configuration using only four magnets 6 with the magnetic materials 5 removed in the present invention. FIG. 6 schematically shows the lines of magnetic force 7 due to the four magnets 6 and the forces 8, 10, and 11 influencing electron beams, in the same way as in FIG. 2. As is apparent from FIG. 6, due to the absence of the magnetic materials 5, a magnetic flux between the two magnets 6 arranged on a line parallel to the y-axis direction expands in the x-axis direction, and the expanding magnetic flux generates force 10 influencing electron beams so as to push them to an outer side in circumferential portions on the x-axis. Furthermore, the magnetic flux directed from the N-pole to the S-pole of each magnet generates force 11 influencing electron beams so as to attract them to the x-axis side in the vicinity of the circumferential portions on the x-axis. That is, considering a change in force influencing electron beams in a direction parallel to the y-axis in the circumferential portions in the x-axis direction, the force 8 that pushes electron beams back to an inner side is generated in the circumferential portions, the force 10 opposite to the force 8, which pushes electron beams to an outer side is generated in the vicinity on the x-axis, and the force 11 that attracts electron beams to the x-axis side is generated in the vicinity of the portions where the direction of this force is reversed. As described above, the PQH misconvergence shown in FIG. 8 is changed as shown in FIG. 7. More specifically, the PQH misconvergence is corrected only partially; on the other hand, in the right-half region, the R vertical line shifts to the right side in the circumferential portions on the x-axis, and in the left-half region, the B vertical line shifts to the left side in the circumferential portions on the x-axis, whereby XH misconvergence occurs. Furthermore, an R horizontal line on the right side and a B horizontal line on the left side are deformed to be distorted due to the force 11 generated at reversion positions of the direction of the force between the forces 8 and 10, whereby PQV misconvergence occurs. Thus, misconvergence is not eliminated as a whole only with the four magnets 6.

According to the present invention, unlike FIGS. 4 to 7, only the PQH misconvergence can be corrected effectively, hardly causing XH misconvergence. According to this configuration, PQH correction can be performed easily. Although XH may be changed slightly according to the present invention, the amount thereof is small, which can be corrected by adjusting the winding distribution of a deflection coil.

The applicable field of the present invention is not particularly limited. For example, the present invention can be used as a color picture tube apparatus such as a TV receiver, a computer display, and the like. In particular, the present invention is effective in a color picture-tube apparatus designed under the condition that PQH misconvergence is likely to occur (e.g., under the condition that the screen is made flat, the deflection angle is increased, the horizontal deflection magnetic field is made uniform, etc.).

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

1. A color picture tube apparatus comprising a deflection yoke including a horizontal deflection coil, a vertical deflection coil, and a core, the apparatus deflecting a plurality of electron beams emitted from an electron gun arranged in an in-line shape using the deflection yoke, and displaying a color image on a phosphor screen,
wherein the apparatus further comprises a pair of bar-shaped elements, each including a magnetic material and magnets disposed at both ends of the magnetic material,
one end in a major axis direction of each of the pair of bar-shaped elements is an N-pole, and the other end is an S-pole, and
the pair of bar-shaped elements sandwich the deflection yoke in a horizontal direction, with the major axis direction thereof being parallel to a vertical direction, and each of the pair of bar-shaped elements is placed at a position between an end of the horizontal deflection coil on the phosphor screen side and a central position of the core in a tube axis direction, in such a manner that magnetic poles at both the ends are opposite to each other between the pair of bar-shaped elements.

2. The color picture tube apparatus according to claim 1, wherein the N-poles and the S-poles at both the ends of the bar-shaped elements are substantially positioned respectively on a diagonal line of the phosphor screen, when seen along a tube axis.

3. The color picture tube apparatus according to claim 1, wherein, assuming that a length in a major axis direction of the magnetic material is a, and each length in a major axis direction of the magnets disposed at both the ends of the magnetic material is b, a relationship: 2b<a<4b is satisfied.
